(19) United States
(12) Patent Application Publication
(10) Pub. No.: US 2025/0274188 A1
(43) Pub. Date: Aug. 28, 2025

(54) BEAM FAILURE DETECTION AND LINK RECOVERY TEST FOR MULTI-TRP OPERATION

(71) Applicant: Intel Corporation, Santa Clara, VA (US)

(72) Inventors: Hua Li, Beijing 11 (CN); Meng Zhang, Beijing (CN); Richard C. Burbidge, Shrivenham (GB); Rui Huang, Beijing (CN); In-Seok Hwang, Santa Clara, CA (US)

(21) Appl. No.: 18/881,642

(22) PCT Filed: Aug. 1, 2023
(86) PCT No.: PCT/US2023/029220

§ 371 Date: Jan. 6, 2025

Related U.S. Application Data
(60) Provisional application No. 63/395,626, filed on Aug. 5, 2022.

(51) Int. Cl. H04B 7/06; H04B 17/318; H04B 17/336; H04L 5/00; H04W 24/08; H04W 24/10; H04W 56/00

(52) U.S. Cl. CPC H04B 7/06964; H04B 17/328; H04B 17/336; H04L 5/0048; H04W 24/08; H04W 24/10; H04W 56/001

(57) ABSTRACT

A user equipment (UE) configured for operation in a fifth-generation (5G) new radio (NR) network may be configured for Transmission-Reception Point (TRP) specific beam failure detection (BFD) and candidate beam detection (CBD) testing. For the BFD and CBD testing, the UE may monitor signal levels of a PSCell within an active downlink bandwidth part (DL-BWP) during an evaluation period, the signal levels of the PSCell including a signal-to-noise ratio (SNR) level of a reference signal received within a first beam set from a first TRP, a layer one (L1) Reference Signal Received Power (RSRP) level of a reference signal received within a second beam set from the first TRP, and a SNR level of a reference signal received within a first beam set from a second TRP.

### PRIORITY CLAIM

This application claims priority to U.S. Provisional Patent Application Ser. No. 63/395,626, filed Aug. 5, 2022 [reference number AE6876-Z]which is incorporated herein by reference in its entirety.

### TECHNICAL FIELD

Embodiments pertain to wireless communications. Some embodiments relate to wireless networks including 3GPP (Third Generation Partnership Project) and fifth-generation (5G) networks including 5G new radio (NR) (or 5G-NR) networks. Some embodiments relate to sixth-generation (6G) networks.

### BACKGROUND

Mobile communications have evolved significantly from early voice systems to today's highly sophisticated integrated communication platform. With the increase in different types of devices communicating with various network devices, usage of 3GPP 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Multiple transmission and reception points (multi-TRPs) have been introduced in 5G networks in order to improve reliability, coverage, and capacity performance through flexible deployment scenarios. Multi-TRP enables 5G gNodeB (gNB) base stations to use more than one transmission and reception point (TRP) to communicate with user equipment (UE). Like many of the R17 enhancements, multi-TRP improvements are aimed to help optimize network performance and robustness. To be able to support the exponential growth in mobile data traffic in 5G and to enhance the coverage, a UE is expected to access networks composed of multi-TRPs (i.e., macro-cells, small cells, picocells, femto-cells, remote radio heads, relay nodes, etc.). One issue with multi-TRP operation is Beam Failure Detection (BFD) and Link Recovery (LR) testing.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2A illustrates multi-TRP operation, in accordance with some embodiments.

FIG. 2B illustrates signal variation for Beam Failure Detection (BFD) and Link Recovery (LR) testing for multi-TRP operations, in accordance with some embodiments; and

FIG. 3 illustrates a functional block diagram of a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to a user equipment (UE) configured for operation in a fifth-generation (5G) new radio (NR) network may be configured for Transmission-Reception Point (TRP) specific beam failure detection (BFD) and candidate beam detection (CBD) testing. For the BFD and CBD testing, the UE may monitor signal levels of the PSCell within an active downlink bandwidth part (DL-BWP) during an evaluation period. The evaluation period comprises sequential time durations T1, T2, T3, T4 and T5. The signal levels of the PSCell may include a signal-to-noise ratio (SNR) level of a reference signal received within a first beam set (q_{0,0}) from a first TRP (TRP 1), a layer one (L1) Reference Signal Received Power (RSRP) (L1-RSRP) level of a reference signal received within a second beam set (q_{0,1}) from the first TRP, and a SNR level of a reference signal received within a first beam set (q_{1,0}) from a second TRP (TRP 2). During a time duration T5, at a time point occurring no later than a predetermined time after a start of the time duration T5, the UE may transmit a preamble on a beam associated with the beam candidates from the second beam set (q_{0,1}) for the first TRP (TRP 1). The UE may refrain from transmitting the preamble on a beam associated with the beam candidates from the second beam set (q_{0,1}) for the first TRP (TRP 1) prior to a time point corresponding to a start of time duration T3. These embodiments, as well as others, are described in more detail below.

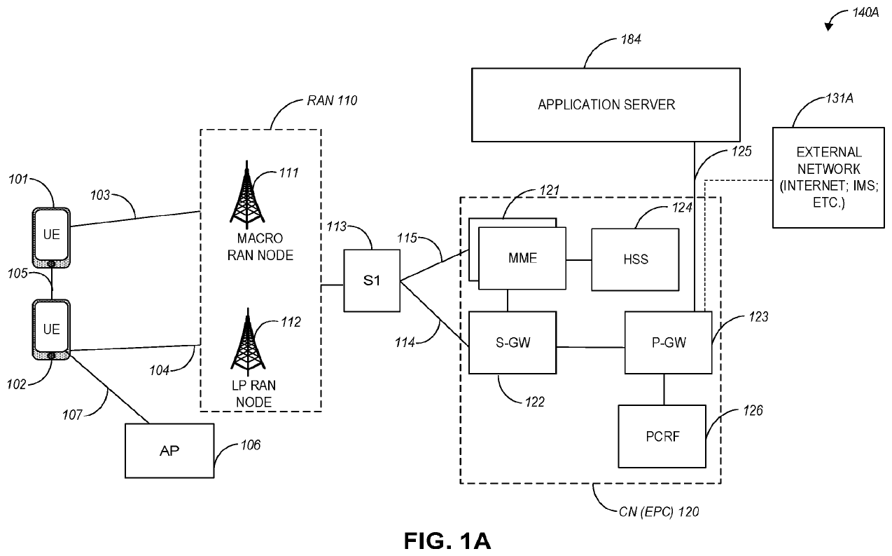

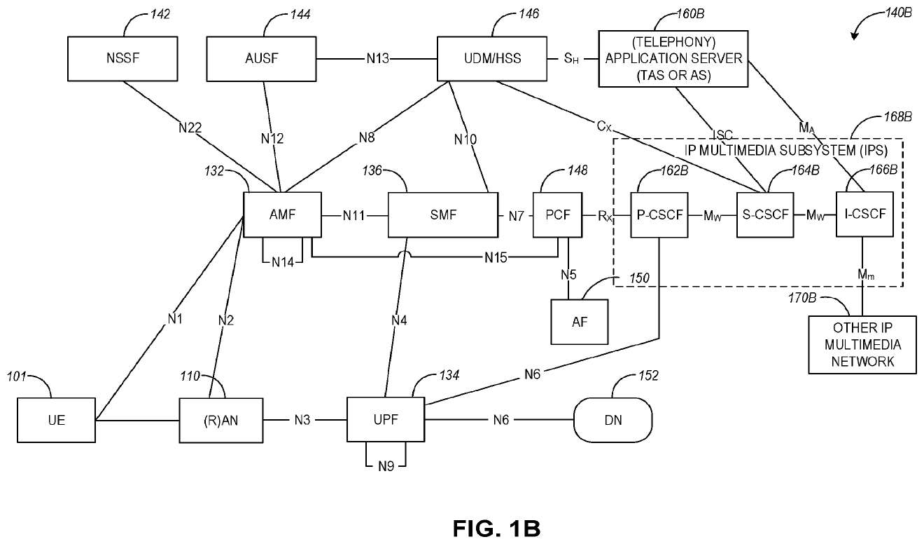

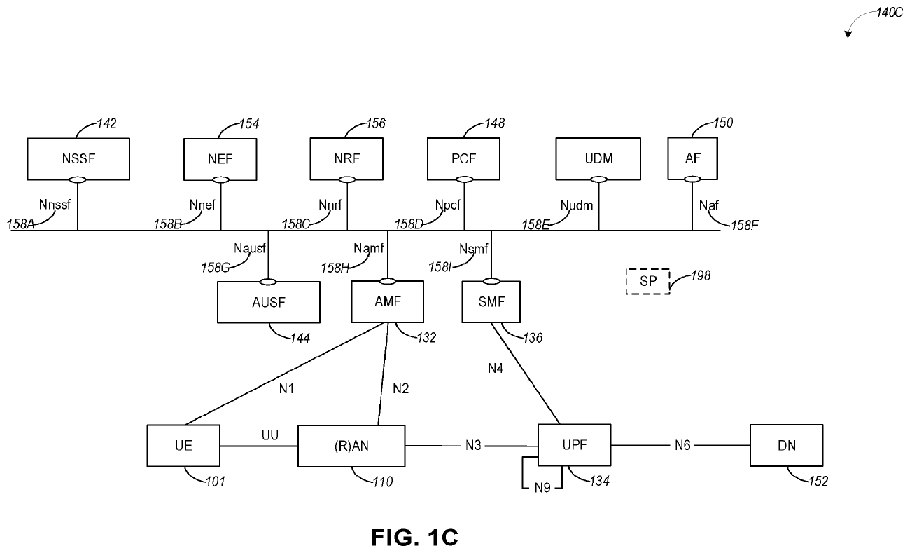

FIG. 1A illustrates an architecture of a network in accordance with some embodiments. The network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UE 101 and UE 102 can be collectively referred to herein as UE 101, and UE 101 can be used to perform one or more of the techniques disclosed herein. Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UE 101 and UE 102 can comprise an Internet-of-Things (IoT) UE or a Cellular IoT (CIoT) UE, which can comprise a network access layer designed for low-power IoT applications utilizing short-lived UE connections. In some embodiments, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UE 101 and UE 102 can include enhanced MTC (eMTC) UEs or further enhanced MTC (FeMTC) UEs.

The UE 101 and UE 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the RAN nodes 111 and 112 can be transmission/reception points (TRPs). In instances when the RAN nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node, and one or more RAN nodes for providing femtocells or picocells (e.g., cells having smaller coverage areas, smaller user capacity, or higher bandwidth compared to macrocells), e.g., low power (LP) RAN node.

Any of the RAN nodes 111 and 112 can terminate the air interface protocol and can be the first point of contact for the UE 101 and UE 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the RAN nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs 134, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

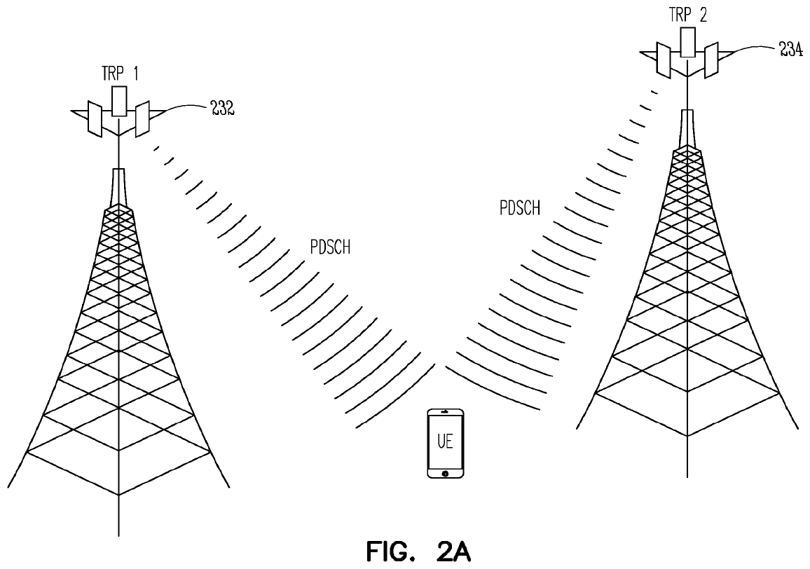

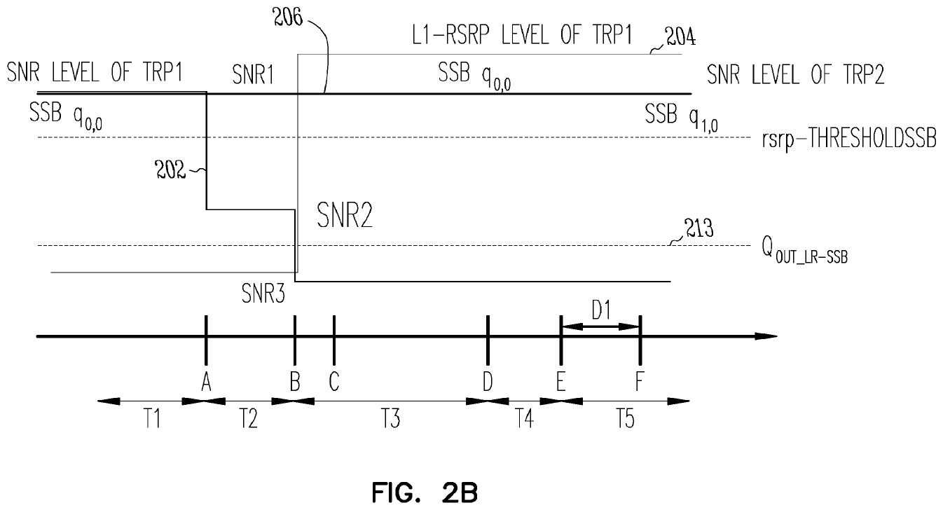

FIG. 2A illustrates multi-TRP operation, in accordance with some embodiments. FIG. 2A illustrates transmission of a physical downlink shared channel (PDSCH) (i.e., data or data channels) from more than one transmission-reception point (TRP) (i.e., TRP1 232 and TRP2 234). TRPs may also be configured for transmission of Physical Downlink Control Channels (PDCCHs). The UE may also be configured for transmission of Physical Uplink Control Channels (PUCCHs) and Physical Uplink Shared Channels (PUSCHs) to more than on TRP. TRP1 232 may utilize two or more beams (e.g., beam set q_{0,0}, q_{0.1}) and TRP2 234 may utilize two or more beams (e.g., beam set q_{1,0}, q_{1,1}). The UE may be configured for Transmission-Reception Point (TRP) specific beam failure detection (BFD) and candidate beam detection (CBD) testing by measuring signals associated with the beam sets. These embodiments are described in more detail below.

Requirements for Transmission-Reception Point (TRP)-specific beam failure detection (BFD) and link recovery may have been previously defined. In some cases, two TRPs will be involved. Embodiments herein relate to testing for TRP-specific BFD and link recovery.

### BFD-Reference Signal (RS) Configuration.

Different from legacy beam failure detection and link recovery test case, two TRPs will be configured. If BFD-RS (or candidate beam detection (CBD)-RS) resource in one TRP is different from BFD-RS (or CBD-RS) resource in another TRP. The UE may perform independent beam failure detection and link recovery for the two TRPs respectively.

In some embodiments, a scaling factor may be introduced when BFD-RS collides (e.g., a BFD-RS from one TRP collides with a BFD-RS from another TRP).

### Issue 3-1-1 the Conditions on Applying P_{TRP}=2 in FR2

When BFD-RS (or CBD-RS) resource in one BFD (or CBD) set are overlapped with the RS resource from the other BFD (or CBD) set, and if a scaling factor is introduced, an extra measurement delay may be needed, which may have impact during times and UE behavior (e.g. T1˜T5 see FIG. 2B). Therefore, in the test, the configuration that BFD-RS of two TRPs that are overlapped will be considered. An example configuration is illustrated in Table 1 and Table 2.

TABLE 1
SSB based BFD and link recovery

| | | TRP1 | TRP2 |
|---|---|---|---|
| SSB index assigned as BFD RS | 1-2 | 0 | 0 |
| SSB index assigned as CBD RS | 1-2 | 1 | 1 |
| SSB index assigned as RLM RS | 1-2 | 0, 1 | 0, 1 |

TABLE 2
CSI-RS based BFD and link recovery

| | TRP1 | TRP2 |
|---|---|---|
| CSI-RS configuration for | CSI-RS.3.2 TDD | CSI-RS.3.2 TDD |
| BFD/CBD/RLM | | |
| CSI-RS index assigned as BFD RS | 0 | 0 |
| CSI-RS index assigned as CBD RS | 1 | 1 |
| CSI-RS index assigned as RLM RS | 0, 1 | 0, 1 |

### SNR and L1-RSRP Variation

Another issue is whether one TRP or both TRPs will detect beam failure and perform link recovery. It is possible that one or both of the channel quality degrades, then one or both TRP detects beam failure. a one TRP detection of beam failure may serve as example to design the SNR variation.

FIG. 2B illustrates signal variation for Beam Failure Detection (BFD) and Link Recovery (LR) testing for multi-TRP operations in accordance with some embodiments. For example, TRP1 will detect beam failure and the beam quality of TRP2 will not degrade. The SNR and L1-RSRP variation are shown in FIG. 2B.

Different from legacy SNR variation, a new line is included in FIG. 2B, which depicts an example SNR level 206 of SSB/CSI-RS in q̅_{1,0} for TRP2. The SNR level 206 may always be at high level for TRP2 during T1˜T5 and no beam failure will happen. SNR level 202 of TRP1 may drop from T2 and UE will detect beam failure during T3. Note that it is also possible that SNR levels of both TRPs will drop and two TRPs will detect BFD and perform link recovery later.

### Time Duration for T1˜T5

An example rule for determining time duration of T1˜T5 is as follows:
T2=BFD evaluation period+CBD evaluation+50 ms margin
T3=BFD evaluation period+40 ms margin
T4=0 ms
T5=CBD evaluation period+50 ms margin
D1=CBD evaluation period+10 ms margin

Because BFD-RS is overlapped for two TRPs, the measurement may be extended. The measurement time may be scaled by factor 2, then the T2˜T5 time will be extended, the updated value are shown in Table 3.

TABLE 3
T1~T5 duration time for TRP specific BFD and link
recovery test.

| | | | T2(s) | T3(s) | | T5(s) | D1(s) |
|---|---|---|---|---|---|---|---|
| | RS | | (BFD time + CBD | (BFD time + | | (CBD time + | (CBD time + |
| FR | type | T1(s) | time + margin) | margin) | T4(s) | margin) | margin) |
| FR2 | SSB | 1 | 2.61 = | 3.24 = | 0 | 1.97 = | 1.93 = |
| | | | 2*1.6 + 2*0.96 + 0.05 | 2*1.6 + 0.04 | | 2*0.96 + 0.05 | 2*0.96 + 0.01 |
| FR2 | CSI- | 1 | 10.81 = | 10.28 = | 0 | 0.57 = | 0.53 = |
| | RS | | 2*5.12 + 2*0.26 + 0.05 | 2*5.12 + 0.04 | | 2*0.26 + 0.05 | 2*0.26 + 0.01 |

The UE behavior during time durations T1, T2, T3, T4 and T5 may be as follows:
During T1, T2, T3, T4, T5, the UE shall transmit uplink signal at least in all subframes configured for CSI transmission on Cell 1 for TRP 2.
During the time duration T1 and T2, the UE shall transmit uplink signal at least in all subframes configured for CSI transmission on Cell 1 for TRP 1 and TRP2.
During the period from time point A to time point B the UE shall transmit uplink signal in Cell 1 for TRP 1 and TRP2 in all uplink slots configured for CSI transmission according to the configured periodic CSI reporting for Cell 1.
During T3 the UE shall detect beam failure and initiate link recovery for TRP 1. During T4 and T5 the UE measures and evaluate beam candidate from beam candidate set q_{0,1}.
No later than time point F occurring no later than D1=[1920]+10 ms after the start of T5, the UE shall transmit preamble on a beam associated with the candidate beam set q_{0,1} for TRP1. The UE shall not transmit preamble on a beam associated with the candidate beam set q_{0,1} earlier than time point B.

In embodiments, the test may be concluded once the test equipment has received the initial preamble transmission from the UE. The rate of correct events observed during repeated tests may be required to be at least 90%.

Some embodiments are directed to a method to be performed by a transmit receive point (TRP), one or more elements of the TRP, and/or one or more electronic devices that include or implement a TRP. The process may include identifying, during beam failure detection (BFD), a collision between a BFD-reference signal (RS) of the TRP and a BFD-RS of another TRP; and adjusting, based on the collision, a parameter of the BFD-RS of the TRP.

In some embodiments, the process may include or relate to a method to be performed by a transmit receive point (TRP), one or more elements of the TRP, and/or one or more electronic devices that include or implement a TRP. The process may include identifying during beam failure detection (BFD), a collision between a BFD-reference signal (RS) of the TRP and a BFD-RS of another TRP; maintaining a timing and/or power parameter of the BFD-RS of the TRP; and identifying, an adjustment of a parameter of the BFD-RS of the other TRP.

A user equipment (UE) configured for operation in a fifth-generation (5G) new radio (NR) network, may be configured for Transmission-Reception Point (TRP) specific beam failure detection (BFD) and candidate beam detection (CBD) testing. In these embodiments, the UE may be synchronized to a first cell (cell 1) and a second cell (cell 2). The first cell may be a primary cell (PCell) and the second cell may be a primary Secondary Cell (PSCell). In these embodiments, the PSCell may be an active serving cell for the UE.

For the BFD and CBD testing, the UE may monitor signal levels of the PSCell within an active downlink bandwidth part (DL-BWP) (i.e., the UE's active DL-BWP) for the BFD and the CBD testing during an evaluation period. In these embodiments, the signal levels of the PSCell may include a signal-to-noise ratio (SNR) level 202 (FIG. 2B) of a reference signal (e.g., an SSB or CSI-RS) received within a first beam set (q_{0,0}) from a first TRP (TRP 1). In these embodiments, the signal levels of the PSCell may also include a layer one (L1) Reference Signal Received Power (RSRP) (L1-RSRP) level 204 (FIG. 2B) of a reference signal received within a second beam set (q_{0,1}) from the first TRP. In these embodiments, the signal levels of the PSCell may also include a SNR level 206 (FIG. 2B) of a reference signal received within a first beam set (q_{1,0}) from a second TRP (TRP 2).

In these embodiments, the UE may not know which signals are from TRP 1 and which signals are from TRP2. After the SNR level 202 of a reference signal within first beam set (q_{0,0}) from the first TRP drops below threshold 213, the UE monitors both the L1-RSRP level 204 of the reference signal received within the second beam set (q_{0,1}) from the first TRP and the SNR level 206 of the reference signal received within the first beam set (q_{1,0}) from the second TRP for the CBD.

In some embodiments, the reference signals may comprise Synchronization Signal Block (SSB) signals for SSB-based BFD and CBD testing. In some embodiments, the reference signals may comprise Channel State Information Reference Signals (CSI-RS) for CSI-RS-based BFD and CBD testing.

In some embodiments, for the SSB-based BFD and CBD testing, the UE may be configured to evaluate whether downlink radio link quality on a configured SSB resource in the beam sets q̅_{0,0} and q_{0,1} estimated over a last T_{Evaluate_BFD_SSB} ms period becomes worse than a threshold Q_{out_LR_SSB} within a T_{Evaluate_BFD_SSB} ms period.

In some embodiments, the evaluation period comprises sequential time durations T1, T2, T3, T4 and T5 (as shown in FIG. 2B). In these embodiments, during the time duration T1, the SNR level 202 of the reference signal received within the first beam set (q_{0,0}) from the first TRP (TRP 1) is above an RSRP threshold 211 (FIG. 2B) and the Q_{out_LR_SSB} threshold 213 (FIG. 2B). In these embodiments, during time duration T2, the SNR level 202 of the reference signal received within the first beam set (q_{0,0}) from the first TRP (TRP 1) falls below the RSRP threshold 211.

In some embodiments, during the time durations T3, T4 and T4, the SNR level of the reference signal received within the first beam set (q_{0,0}) from the first TRP (TRP 1) is below the Q_{out_LR_SSB} threshold 213.

In some embodiments, during the time duration T3, the UE may detect beam failure for the first TRP (TRP 1) and initiate a link recovery for the first TRP. In these embodiments, during the time durations T4 and T5, the UE may measure and evaluate beam candidates from the second beam set (q_{0,1}) for the first TRP (TRP 1). In these embodiments, during the time duration T5, at a time point F occurring no later than a predetermined time after a start of the time duration T5, the UE may transmit a preamble on a beam associated with the beam candidates from the second beam set (q_{0,1}) for the first TRP (TRP 1).

In some embodiments, the UE may refrain from transmitting the preamble on a beam associated with the beam candidates from the second beam set (q_{0,1}) for the first TRP (TRP 1) prior to a time point B corresponding to a start of time duration T3.

In some embodiments, during the time durations T1, T2, T3, T4 and T5, the UE may transmit uplink signals in all subframes configured for a CSI transmission on the first cell (cell 1) for the second TRP (TRP 2). In these embodiments, during the time durations T1 and T2, the UE may transmit uplink signals in all subframes configured for a CSI transmission on the first cell (cell 1) for both the first TRP and the second TRP (TRP 1 and TRP 2). In some of these embodiments, during the time duration T2, (i.e., the period from time point A to time point B) the UE may transmit uplink signals in the first cell (Cell 1) for the first TRP and the second TRP (TRP 1 and TRP 2) in all uplink slots configured for CSI transmission according to a configured periodic CSI reporting for the first cell (Cell 1).

In some embodiments, transmission of the preamble may comprise an uplink transmission followed by a beam failure report containing the second beam set (q_{0,1}) of the first TRP. In some embodiments, transmission of the preamble comprises a PUCCH encoded for transmission followed by a beam failure report (BFR) medium-access control (MAC) control element (CE) (BFR MAC CE) containing (i.e., identifying) the second beam set (q_{0,1}) of the first TRP.

In some embodiments, during time durations T1, T2, T3, T4 and T5, the SNR level 206 of the reference signal received within the first beam set (q_{1,0}) from the second TRP (TRP 2) may be above the RSRP threshold 211 and the Q_{out_LR_SSB} threshold 213.

Some embodiments are directed to a non-transitory computer-readable storage medium that stores instructions for execution by processing circuitry of a user equipment (UE) configured for operation in a fifth-generation (5G) new radio (NR) network. In these embodiments, to configure the UE for Transmission-Reception Point (TRP) specific beam failure detection (BFD) and candidate beam detection (CBD) testing, the processing circuitry may be configured to synchronize the UE to a first cell (cell 1) and a second cell (cell 2). In these embodiments, the UE may be synchronized to a first cell (cell 1) and a second cell (cell 2). The first cell may be a primary cell (PCell) and the second cell may be a primary Secondary Cell (PSCell). In these embodiments, the PSCell may be an active serving cell for the UE.

For the BFD and CBD testing, the UE may monitor signal levels of the PSCell within an active downlink bandwidth part (DL-BWP) (i.e., the UE's active DL-BWP) for the BFD and the CBD testing during an evaluation period. In these embodiments, the signal levels of the PSCell may include a signal-to-noise ratio (SNR) level 202 of a reference signal (e.g., an SSB or CSI-RS) received within a first beam set (q_{0,0}) from a first TRP (TRP 1). In these embodiments, the signal levels of the PSCell may also include a layer one (L1) Reference Signal Received Power (RSRP) (L1-RSRP) level 204 of a reference signal received within a second beam set (q_{0,1}) from the first TRP. In these embodiments, the signal levels of the PSCell may also include a SNR level 206 of a reference signal received within a first beam set (q_{1,0}) from a second TRP (TRP 2).

Some embodiments are directed to a non-transitory computer-readable storage medium that stores instructions for execution by processing circuitry of test equipment (TE) for verifying that a user equipment (UE), configured for operation in a fifth-generation (5G) new radio (NR) network, correctly performs Transmission-Reception Point (TRP) specific beam failure detection (BFD) and candidate beam detection (CBD). In these embodiments, for TRP specific BFD and CBD testing, the processing circuitry is configured to synchronize the UE to a first cell (cell 1) and a second cell (cell 2). The first cell may be a primary cell (PCell) and the second cell may be a primary Secondary Cell (PSCell). The PSCell may be an active serving cell for the UE. In these embodiments, the TRPs may be configured to generate signal levels of the PSCell within an active downlink bandwidth part (DL-BWP) for the BFD and the CBD testing during an evaluation period. In these embodiments, the signal levels of the PSCell may include a signal-to-noise ratio (SNR) level 202 of a reference signal (e.g., an SSB or CSI-RS) received within a first beam set (q_{0,0}) from a first TRP (TRP 1). In these embodiments, the signal levels of the PSCell may also include a layer one (L1) Reference Signal Received Power (RSRP) (L1-RSRP) level 204 of a reference signal received within a second beam set (q_{0,1}) from the first TRP. In these embodiments, the signal levels of the PSCell may also include a SNR level 206 of a reference signal received within a first beam set (q_{1,0}) from a second TRP (TRP 2). In these embodiments, the reference signals may comprise Synchronization Signal Block (SSB) signals for SSB-based BFD and CBD testing or Channel State Information Reference Signals (CSI-RS) for CSI-RS-based BFD and CBD testing.

In these embodiments, the test equipment may simulate the operations performed by a gNB and its TRPs for verifying that a UE correctly performs Transmission-Reception Point (TRP) specific beam failure detection (BFD) and candidate beam detection (CBD) as described herein.

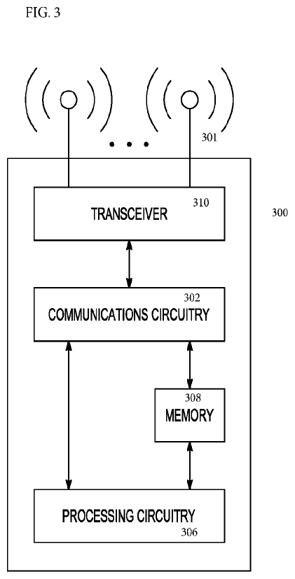

FIG. 3 illustrates a functional block diagram of a wireless communication device, in accordance with some embodiments. Wireless communication device 300 may be suitable for use as a UE or gNB configured for operation in a 5G NR or 6G network, although the scope of the embodiments is not limited in this respect.

The wireless communication device 300 may include communications circuitry 302 and a transceiver 310 for transmitting and receiving signals to and from other communication devices using one or more antennas 301. The communications circuitry 302 may include circuitry that can operate the physical layer (PHY) communications and/or medium access control (MAC) communications for controlling access to the wireless medium, and/or any other communications layers for transmitting and receiving signals. The wireless communication device 300 may also include processing circuitry 306 and memory 308 arranged to perform the operations described herein. In some embodiments, the communications circuitry 302 and the processing circuitry 306 may be configured to perform operations detailed in the above figures, diagrams, and flows.

In accordance with some embodiments, the communications circuitry 302 may be arranged to contend for a wireless medium and configure frames or packets for communicating over the wireless medium. The communications circuitry 302 may be arranged to transmit and receive signals. The communications circuitry 302 may also include circuitry for modulation/demodulation, upconversion/downconversion, filtering, amplification, etc. In some embodiments, the processing circuitry 306 of the wireless communication device 300 may include one or more processors. In other embodiments, two or more antennas 301 may be coupled to the communications circuitry 302 arranged for sending and receiving signals. The memory 308 may store information for configuring the processing circuitry 306 to perform operations for configuring and transmitting message frames and performing the various operations described herein. The memory 308 may include any type of memory, including non-transitory memory, for storing information in a form readable by a machine (e.g., a computer). For example, the memory 308 may include a computer-readable storage device, read-only memory (ROM), random-access memory (RAM), magnetic disk storage media, optical storage media, flash-memory devices and other storage devices and media.

In some embodiments, the wireless communication device 300 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 300 may include one or more antennas 301. The antennas 301 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 300 may include one or more of a keyboard, a display, a non-volatile memory port, multiple antennas, a graphics processor, an application processor, speakers, and other mobile device elements. The display may be an LCD screen including a touch screen.

Although the wireless communication device 300 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 300 may refer to one or more processes operating on one or more processing elements.

### EXAMPLES

Example 1 may include for TRP specific beam failure detection testcase, configuration of BFD-RS of two TRPs are overlapped.

Example 2 may include in the test, one TRP or both TRPs can detect beam failure and perform link recovery. For example,

Example 3 may include if TRP1 detects beam failure and perform link recovery, SNR of TRP1 will drop from T2 and UE will detect beam failure during T3, as shown in FIG. 2B. The SNR always keep at high level for TRP2 during T1˜T5.

Example 4 may include the measurement time will be scaled by factor 2, then the T2˜T5 time will be extended, the updated value of table 2 may be used.

Example 5 may include during the period from time point A to time point B the UE shall transmit uplink signal in Cell 1 for TRP 1 and TRP2 in all uplink slots configured for CSI transmission according to the configured periodic CSI reporting for Cell 1.

Example 6 may include during T3 the UE shall detect beam failure and initiate link recovery for TRP 1. During T4 and T5 the UE measures and evaluate beam candidate from beam candidate set q_{0,1}.

Example 7 includes a method to be performed by a transmit receive point (TRP), one or more elements of the TRP, and/or one or more electronic devices that include or implement a TRP, wherein the method comprises: identifying, during beam failure detection (BFD), a collision between a BFD-reference signal (RS) of the TRP and a BFD-RS of another TRP; and adjusting, based on the collision, a parameter of the BFD-RS of the TRP.

Example 8 includes the method of example 7, and/or some other example herein, wherein the identification of the collision is based on identification of failure of BFD.

Example 9 includes the method of any of examples 7 or 8, and/or some other example herein wherein the adjustment includes an adjustment to a signal to noise ratio (SNR) of the TRP.

Example 10 includes the method of any of examples 7-9, and/or some other example herein, wherein the adjustment includes an adjustment to timing of BFD.

Example 11 includes the method of any of examples 7-10, and/or some other example herein, wherein the BFD-RS of the other TRP is not adjusted.

Example 12 includes a method to be performed by a transmit receive point (TRP), one or more elements of the TRP, and/or one or more electronic devices that include or implement a TRP, wherein the method comprises: identifying, during beam failure detection (BFD), a collision between a BFD-reference signal (RS) of the TRP and a BFD-RS of another TRP; maintaining a timing and/or power parameter of the BFD-RS of the TRP; and identifying an adjustment of a parameter of the BFD-RS of the other TRP.

Example 13 includes the method of example 12, and/or some other example herein, wherein the identification of the collision is based on identification of failure of BFD at the other TRP.

Example 14 includes the method of any of examples 12 or 13, and/or some other example herein wherein the adjustment includes an adjustment to a signal to noise ratio (SNR) of the other TRP.

Example 15 includes the method of any of examples 12-14, and/or some other example herein, wherein the adjustment includes an adjustment to timing of BFD at the other TRP.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus of a user equipment (UE) configured for operation in a fifth-generation (5G) new radio (NR) network, the apparatus comprising: processing circuitry; and memory,
wherein to configure the UE for Transmission-Reception Point (TRP) specific beam failure detection (BFD) and candidate beam detection (CBD) testing, the processing circuitry is configured to:
synchronize the UE to a first cell and a second cell, the first cell being a primary cell (PCell), the second cell being a primary Secondary Cell (PSCell), the PSCell being an active serving cell for the UE; and
monitor signal levels of the PSCell within an active downlink bandwidth part (DL-BWP) for the BFD and the CBD testing during an evaluation period, the signal levels of the PSCell including:
a signal-to-noise ratio (SNR) level of a reference signal received within a first beam set (q_{0,0}) from a first TRP;
a layer one (L1) Reference Signal Received Power (RSRP) (L1-RSRP) level of a reference signal received within a second beam set (q_{0,1}) from the first TRP; and
a SNR level of a reference signal received within a first beam set (q_{1,0}) from a second TRP,
wherein the memory is configured to store the SNR level of the reference signal received with the first beam set from the first TRP.

2. The apparatus of claim 1, wherein the reference signals comprise:
Synchronization Signal Block (SSB) signals for SSB-based BFD and CBD testing; and
Channel State Information Reference Signals (CSI-RS) for CSI-RS-based BFD and CBD testing.

3. The apparatus of claim 2, wherein for the SSB-based BFD and CBD testing, the processing circuitry is configured to evaluate whether downlink radio link quality on a configured SSB resource in the beam sets q̅_{0,0} and q̅_{0,1} estimated over a last T_{Evaluate_BFD_SSB} ms period becomes worse than a threshold Q_{out_LR_SSB} within a T_{Evaluate_BFD_SSB} ms period.

4. The apparatus of claim 2, wherein the evaluation period comprises time durations T1, T2, T3, T4 and T5,
wherein during the time duration T1, the SNR level of the reference signal received within the first beam set (q_{0,0}) from the first TRP is above an RSRP threshold and the threshold Q_{out_LR_SSB}; and
wherein during time duration T2, the SNR level of the reference signal received within the first beam set (q_{0,0}) from the first TRP falls below the RSRP threshold.

5. The apparatus of claim 4, wherein during the time durations T3, T4 and T4, the SNR level of the reference signal received within the first beam set (q_{0,0}) from the first TRP is below the threshold Q_{out_LR_SSB}.

6. The apparatus of claim 5, wherein during the time duration T3, the processing circuitry is configured to detect beam failure for the first TRP and initiate a link recovery for the first TRP,
wherein during the time durations T4 and T5, the processing circuitry is to configure the UE to measure and evaluate beam candidates from the second beam set (q_{0,1}) for the first TRP; and
wherein during the time duration T5, at a time point occurring no later than a predetermined time after a start of the time duration T5, the processing circuitry is to configure the UE to transmit a preamble on a beam associated with the beam candidates from the second beam set (q_{0,1}) for the first TRP.

7. The apparatus of claim 6, wherein the processing circuitry is to configure to UE to refrain from transmitting the preamble on a beam associated with the beam candidates from the second beam set (q_{0,1}) for the first TRP prior to a time point corresponding to a start of time duration T3.

8. The apparatus of claim 6, wherein during the time durations T1, T2, T3, T4 and T5, the processing circuitry is to configure the UE to transmit uplink signals in all subframes configured for a CSI transmission on the first cell for the second TRP;
wherein during the time durations T1 and T2, the processing circuitry is to configure the UE to transmit uplink signals in all subframes configured for a CSI transmission on the first cell for both the first TRP and the second TRP; and
wherein during the time duration T2, the processing circuitry is to configure the UE to transmit uplink signals in the first cell for the first TRP and the second TRP in all uplink slots configured for CSI transmission according to a configured periodic CSI reporting for the first cell.

9. The apparatus of claim 6, wherein transmission of the preamble comprises an uplink transmission followed by a beam failure report containing the second beam set (q_{0,1}) of the first TRP.

10. The apparatus of claim 6, wherein during time durations T1, T2, T3, T4 and T5, the SNR level of the reference signal received within the first beam set (q_{1,0}) from the second TRP is above the RSRP threshold and the threshold Q_{out_LR_SSB}.

11. A computer-readable storage medium that stores instructions for execution by processing circuitry of a user equipment (UE) configured for operation in a fifth-generation (5G) new radio (NR) network, wherein to configure the UE for Transmission-Reception Point (TRP) specific beam failure detection (BFD) and candidate beam detection (CBD) testing, the processing circuitry is configured to:
synchronize the UE to a first cell and a second cell, the first cell being a primary cell (PCell), the second cell being a primary Secondary Cell (PSCell), the PSCell being an active serving cell for the UE; and
monitor signal levels of the PSCell within an active downlink bandwidth part (DL-BWP) for the BFD and the CBD during an evaluation period, the signal levels of the PSCell including:
a signal-to-noise ratio (SNR) level of a reference signal received within a first beam set (q_{0,0}) from a first TRP;
a layer one (L1) Reference Signal Received Power (RSRP) (L1-RSRP) level of a reference signal received within a second beam set (q_{0,1}) from the first TRP; and
a SNR level of a reference signal received within a first beam set (q_{1,0}) from a second TRP.

12. The computer-readable storage medium of claim 11, wherein the reference signals comprise:
Synchronization Signal Block (SSB) signals for SSB-based BFD and CBD testing; and
Channel State Information Reference Signals (CSI-RS) for CSI-RS-based BFD and CBD testing.

13. The computer-readable storage medium of claim 12, wherein for the SSB-based BFD and CBD testing, the processing circuitry is configured to evaluate whether downlink radio link quality on a configured SSB resource in the beam sets and, estimated over a last T_{Evaluate_BFD_SSB} ms period becomes worse than a threshold Q_{out_LR_SSB} within a T_{Evaluate_BFD_SSB} ms period.

14. The computer-readable storage medium of claim 12, wherein the evaluation period comprises time durations T1, T2, T3, T4 and T5,
wherein during the time duration T1, the SNR level of the reference signal received within the first beam set (q_{0,0}) from the first TRP is above an RSRP threshold and the threshold Q_{out_LR_SSB}; and
wherein during time duration T2, the SNR level of the reference signal received within the first beam set (q_{0,0}) from the first TRP falls below the RSRP threshold.

15. The computer-readable storage medium of claim 14, wherein during the time durations T3, T4 and T4, the SNR level of the reference signal received within the first beam set (q_{0,0}) from the first TRP is below the threshold Q_{out_LR_SSB}.

16. The computer-readable storage medium of claim 15, wherein during the time duration T3, the processing circuitry is configured to detect beam failure for the first TRP and initiate a link recovery for the first TRP,
wherein during the time durations T4 and T5, the processing circuitry is to configure the UE to measure and evaluate beam candidates from the second beam set (q_{0,1}) for the first TRP; and
wherein during the time duration T5, at a time point occurring no later than a predetermined time after a start of the time duration T5, the processing circuitry is to configure the UE to transmit a preamble on a beam associated with the beam candidates from the second beam set (q_{0,1}) for the first TRP.

17. The computer-readable storage medium of claim 16, wherein the processing circuitry is to configure to UE to refrain from transmitting the preamble on a beam associated with the beam candidates from the second beam set (q_{0,1}) for the first TRP prior to a time point corresponding to a start of time duration T3.

18. The computer-readable storage medium of claim 16, wherein during the time durations T1, T2, T3, T4 and T5, the processing circuitry is to configure the UE to transmit uplink signals in all subframes configured for a CSI transmission on the first cell for the second TRP;
wherein during the time durations T1 and T2, the processing circuitry is to configure the UE to transmit uplink signals in all subframes configured for a CSI transmission on the first cell for both the first TRP and the second TRP; and
wherein during the time duration T2, the processing circuitry is to configure the UE to transmit uplink signals in the first cell for the first TRP and the second TRP in all uplink slots configured for CSI transmission according to a configured periodic CSI reporting for the first cell.

19. A computer-readable storage medium that stores instructions for execution by processing circuitry of test equipment (TE) configured to verify that a user equipment (UE), configured for operation in a fifth-generation (5G) new radio (NR) network, correctly performs Transmission-Reception Point (TRP) specific beam failure detection (BFD) and candidate beam detection (CBD), wherein for TRP specific BFD and CBD testing, the processing circuitry is configured to:
synchronize the UE to a first cell and a second cell, the first cell being a primary cell (PCell), the second cell being a primary Secondary Cell (PSCell), the PSCell being an active serving cell for the UE; and
configure a first TRP and a second TRP to generate signal levels of the PSCell within an active downlink bandwidth part (DL-BWP) for the BFD and the CBD testing during an evaluation period, the signal levels of the PSCell including:
a signal-to-noise ratio (SNR) level of a reference signal received within a first beam set (q_{0,0}) from the first TRP;
a layer one (L1) Reference Signal Received Power (RSRP) (L1-RSRP) level of a reference signal received within a second beam set (q_{0,1}) from the first TRP; and
a SNR level of a reference signal received within a first beam set (q_{1,0}) from the second TRP.

20. The computer-readable storage medium of claim 19, wherein the reference signals comprise:
Synchronization Signal Block (SSB) signals for SSB-based BFD and CBD testing; and
Channel State Information Reference Signals (CSI-RS) for CSI-RS-based BFD and CBD testing.
